(19) United States
(12) Patent Application Publication
(10) Pub. No.: US 2025/0335006 A1
(43) Pub. Date: Oct. 30, 2025

(54) Electronic Device with Unitary Flexible Display and Translator and Corresponding Methods

(71) Applicant: Motorola Mobility LLC, Chicago, IL (US)

(72) Inventors: Ioannis A. Zigras, Chicago, IL (US); Ketan Patel, Roselle, IL (US); Mayank Gupta, Naperville, IL (US); Michael Jang, Chicago, IL (US)

(21) Appl. No.: 18/737,674

(22) Filed: Jun. 7, 2024

(30) Foreign Application Priority Data
Apr. 25, 2024 (GR) 20240100301

(51) Int. Cl. G06F 1/16; H04M 1/02

(52) U.S. Cl. CPC G06F 1/1652; G06F 1/1618; H04M 1/0268; G06F 1/1643

(57) ABSTRACT

An electronic device includes a device housing, a unitary flexible display coupled to the device housing and having at least two end portions extending distally from a base portion, and a translator coupled to the unitary flexible display. The translator is operable to selectively move the at least two end portions between a first position where the at least two end portions abut the device housing and a second position where the at least two end portions extend distally from the device housing. A first device housing can also be pivotable relative to a second device housing between an axially displaced open position and closed position. The combination of extendable display and pivoting action allows the electronic device to be configured in any of a clamshell configuration, a slab configuration, or a tablet configuration.

### CROSS REFERENCE TO PRIOR APPLICATIONS

This application claims priority and benefit under 35 U.S.C. § 119 from Greek patent application No. 20240100301, filed Apr. 25, 2024, which is incorporated by reference by rule in accordance with 37 CFR § 1.57.

### BACKGROUND

### Technical Field

This disclosure relates generally to electronic devices, and more particularly to electronic devices having flexible displays.

### Background Art

Contemporary mobile technology strives to balance user demands for both compactness and expansive visual interfaces. Devices that offer large screens are advantageous for activities such as multitasking and viewing media, but often present challenges in terms of transportability due to their size when in use. Smaller, more transportable devices fail to provide the expansive screen space that enhances user experience for certain applications. Consumers are frequently faced with the decision to prioritize either screen size or portability, which may lead to owning multiple devices to fulfill different usage scenarios. It would thus be desirable to have an improved electronic device that not only provides a compact geometric form factor but that allows for the use of a larger display surface area as well.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates a rear elevation view one explanatory electronic device in an axially displaced open position with a unitary flexible display having at least two end portions situated in a first position where they abut a device housing in accordance with one or more embodiments of the disclosure.

FIG. 2 illustrates a front elevation view of the explanatory electronic device of FIG. 1.

FIG. 3 illustrates a top plan view of the explanatory electronic device of FIG. 1.

FIG. 4 illustrates a rear elevation view of the explanatory electronic device of FIG. 1 when a translator coupled to the unitary flexible display has moved the at least one two end portions partially between a first position where the at least two end portions abut the device housing and a second position where the at least two end portions extend distally from the device housing in accordance with one or more embodiments of the disclosure.

FIG. 5 illustrates a front elevation view of the explanatory electronic device of FIG. 4.

FIG. 6 illustrates a top plan view of the explanatory electronic device of FIG. 4.

FIG. 7 illustrates a rear elevation view of the explanatory electronic device of FIG. 1 when the translator coupled to the unitary flexible display has moved the at least one two end portions to the second position where the at least two end portions extend distally from the device housing in accordance with one or more embodiments of the disclosure.

FIG. 8 illustrates a front elevation view of the explanatory electronic device of FIG. 7.

FIG. 9 illustrates a top plan view of the explanatory electronic device of FIG. 7.

FIG. 10 illustrates the explanatory electronic device of FIG. 1 when the first device housing and second device housing are folded about the hinge partially between the axially displaced open position and the closed position to a tent position in accordance with one or more embodiments of the disclosure.

FIG. 11 illustrates the explanatory electronic device of FIG. 1 when the first device housing is pivoted about the hinge to the closed position in accordance with one or more embodiments of the disclosure.

FIG. 12 illustrates another explanatory electronic device in accordance with one or more embodiments of the disclosure.

FIG. 13 illustrates one explanatory method in accordance with one or more embodiments of the disclosure.

FIG. 14 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to utilizing a translator coupled to a unitary flexible display in an electronic device to selectively move at least two end portions of the unitary flexible display between a first position where the at least two end portions abut the device housing of the electronic device an display assembly second position where the at least two end portions extend distally from the housing. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of receiving, by a user interface, user input requesting a unitary flexible display coupled to a device housing and having at least two separated end portions extending distally from a base portion to transition the at least two separated end portions between a first position where the at least two separated end portions abut the device housing and a second position where the at least two separated end portions extend distally from the device housing and translating, using a translator, the unitary flexible display in response to the user input as described herein. The non-processor circuits may include, but are not limited to, a radio receiver, a radio transmitter, signal drivers, clock circuits, power source circuits, and user input devices. As such, these functions may be interpreted as steps of a method to perform selectively configuring an electronic device having a unitary flexible display comprising a base portion, a first portion extending from the base portion, and a second portion extending from the base portion in one of a tablet configuration, a slab configuration, and a clamshell configuration.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide an electronic device that is both “foldable” and “rollable” and that aims to address the limitations of current mobile devices in terms of providing both a compact form factor for “pocketability” and the conflicting desire of users to enjoy large display experiences. In one or more embodiments, an electronic device configured in accordance with one or more embodiments of the disclosure allows for a transformation of a “pocketable” electronic device from a clamshell configuration into a “slab” configuration by unfolding it in a hamburger style. Thereafter, the electronic device can be transformed from the slab configuration to a tablet configuration when a translator coupled to a unitary flexible display having at least two separated end portions that can move between a first position where they abut the device housing and a second position where they extend distally from the device housing translates the at least two separated end portions to the second position. In effect, the translator and its telescoping sections can transform the electronic device, when a first device housing and second device housing are pivoted to an axially displaced open position, into a tablet style by “unwrapping” the at least two separated end portions around the device housing.

In one or more embodiments, an electronic device comprises a device housing, a unitary flexible display, and a translator. The unitary flexible display is coupled to the device housing and has at least two end portions that can extend distally from a base portion. The translator is responsible for selectively moving the end portions between a first position where they abut the device housing and a second position where they extend distally from the device housing.

In one or more embodiments, the device housing of the electronic device also includes a hinge mechanism that allows a first device housing to pivot about the hinge relative to a second device housing between an axially displaced open position and a closed position. In one or more embodiments, the translator can move the unitary flexible display in a rollable manner causing an edge of the unitary flexible display to extend and retract. This translation effect allows the electronic device to transition between different configurations, such as a tablet configuration, a slab configuration, and a clamshell configuration.

The device offers a unique combination of pocketability and a large display, addressing the limitations of current folio style and clamshell phones. It further provides a cost-effective solution compared to owning separate devices for different usage scenarios. Embodiments of the disclosure also offer an exciting business proposition, as the expand the use cases of clamshell phones to allow for tablet-style consumption.

The claims further define the specific features and functionalities of the invention. They describe the electronic device, the method of transitioning the display, and the different configurations it can assume. The claims emphasize the flexibility and versatility of the device, allowing users to enjoy a large display experience while maintaining portability.

Overall, the invention disclosure presents a novel solution to the challenges faced by current mobile devices. It offers a unique combination of pocketability and a large display, providing users with a versatile and convenient device for various usage scenarios.

In one or more embodiments, an electronic device comprises a device housing, a unitary flexible display coupled to the device housing and having at least two end portions extending distally from a base portion, and a translator coupled to the unitary flexible display. The translator is operable to selectively move the at least two end portions between a first position where the at least two end portions abut the device housing and a second position where the at least two end portions extend distally from the device housing. A first device housing can also be pivotable relative to a second device housing between an axially displaced open position and closed position. The combination of extendable display and pivoting action allows the electronic device to be configured in any of a clamshell configuration, a slab configuration, or a tablet configuration.

Methods for using electronic devices configured in accordance with one or more embodiments of the disclosure are also disclosed herein. Illustrating by example, in one or more embodiments a method in an electronic device comprises receiving, by a user interface, user input requesting a unitary flexible display coupled to a device housing and having at least two separated end portions extending distally from a base portion to transition the at least two separated end portions between a first position where the at least two separated end portions abut the device housing and a second position where the at least two separated end portions extend distally from the device housing. Thereafter, the method comprises translating, by a translator coupled to the unitary flexible display, the at least two separated end portions in response to the user input.

Advantageously, when the device housing also comprises a first device housing that is pivotable about a hinge relative to a second device housing between an axially displaced open position and a closed position, this allows wherein the electronic device is operable different configurations. In an exemplary embodiment, these configurations comprise (1) a tablet configuration when the first device housing is pivoted to the axially displaced open position relative to the second device housing, the first portion extends distally from the first device housing, and the second portion extends distally from the second device housing, (2) a slab configuration when the first device housing is pivoted to the axially displaced open position relative to the second device housing, the first portion abuts the first device housing, and the second portion abuts the second device housing, and (3) a clamshell configuration when the first portion abuts the first device housing, the second portion abuts the second device housing, and the first device housing is pivoted relative to the second device housing to the closed position.

Embodiments of the disclosure provide numerous advantages over prior art devices. Particularly, an electronic device that can be folded into a clamshell configuration, unfolded to a slab configuration, and extended into a tablet configuration offers the following advantages and benefits:

Pocketability: When folded into a clamshell configuration, the device becomes compact and easily fits into a pocket or small bag. This allows for convenient and hassle-free portability.

Phone Functionality: When unfolded to a slab configuration, the device functions as a regular mobile phone, providing all the essential features and capabilities of a traditional smartphone. Users can make calls, send messages, and access various apps and services.

Large Display Experience: By extending the device into a tablet configuration, users can enjoy a significantly larger display for enhanced viewing experiences. This is particularly advantageous for watching videos, movies, and other multimedia content, as it provides a more immersive and enjoyable visual experience.

Versatility: The ability to switch between different configurations offers users the flexibility to adapt the device to their specific needs and preferences. Whether they require a compact phone for on-the-go use, a larger display for media consumption, or a tablet-like experience for productivity tasks, the device can seamlessly transition between these modes.

Convenience and Cost-effectiveness: Having a single device that can fulfill the functions of a phone, a compact device, and a tablet eliminates the need to carry multiple devices or invest in separate gadgets. This not only saves money but also simplifies the user experience by consolidating all functionalities into one device.

Enhanced Productivity: The larger display in the tablet configuration allows for improved multitasking and productivity. Users can comfortably view and work on documents, spreadsheets, presentations, and other content, making it ideal for professionals or individuals who require a larger screen for their work.

Overall, an electronic device that offers the flexibility to fold into a clamshell configuration, unfold to a slab configuration, and extend into a tablet configuration provides users with the best of both worlds-pocketability and a large display experience. It combines convenience, versatility, and cost-effectiveness, catering to the diverse needs and preferences of modern users. Other advantages will be described below. Still others will be obvious to those of ordinary skill in the art having the benefit of this disclosure.

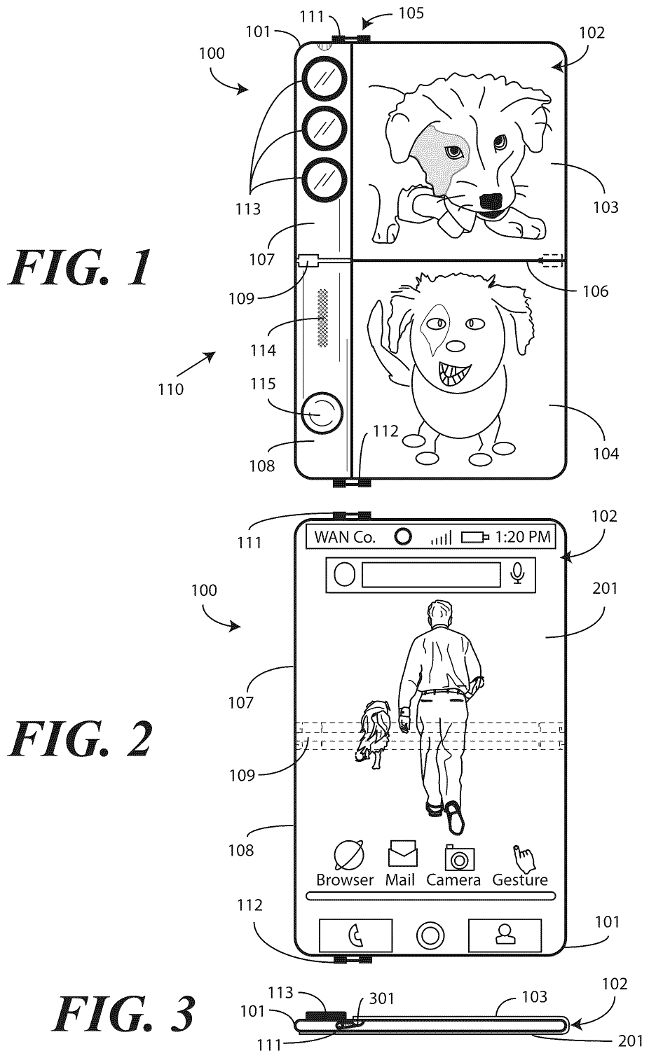

Turning now to FIGS. 1-3, illustrated therein is one explanatory electronic device 100 configured in accordance with one or more embodiments of the disclosure. Turning now to FIG. 1, illustrated therein is one explanatory electronic device 100 configured in accordance with one or more embodiments of the disclosure. The electronic device 100 of FIG. 1 is a portable electronic device. For illustrative purposes, the electronic device 100 is shown in a slab configuration in FIG. 1 where it primarily functions as a smartphone. However, given the versatility and flexibility offered by the ability of the electronic device 100 to fold and the ability of a unitary flexible display 102 to expand, the electronic device 100 can easily function as any number of other devices as well based upon geometric configuration, including tablet computers, gaming devices, multimedia players, and so forth. Still other functions for the electronic device 100 will be readily appreciated by those of ordinary skill in the art having the benefit of this disclosure.

In one or more embodiments, the electronic device 100 includes a device housing 101. While the device housing 101 can be a single device housing in some embodiments, in the illustrative embodiment of FIG. 1 the device housing 101 comprises a first device housing 107 and a second device housing 108.

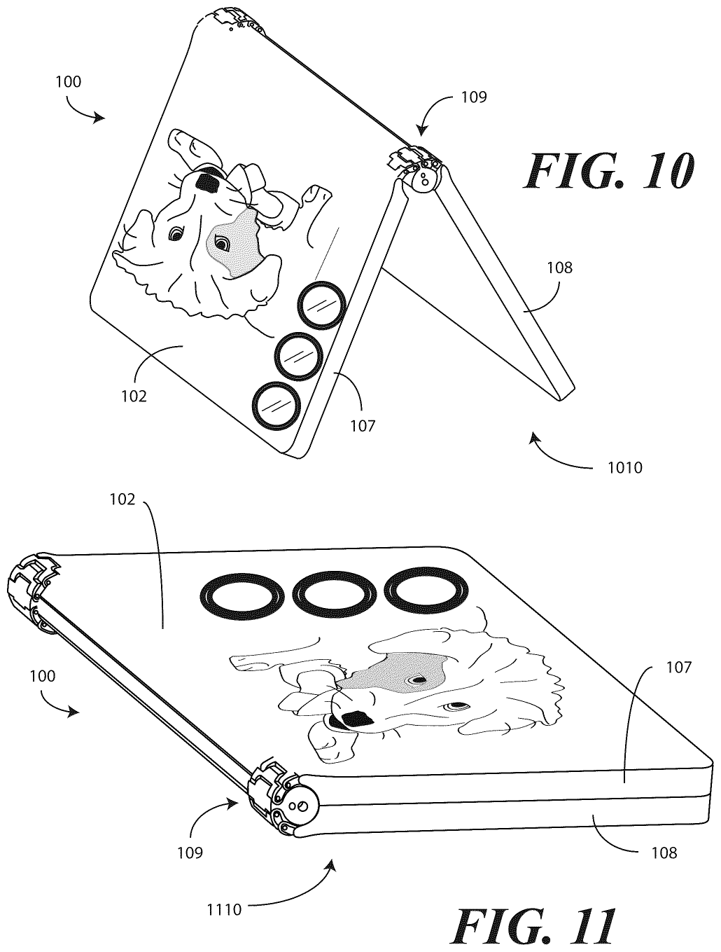

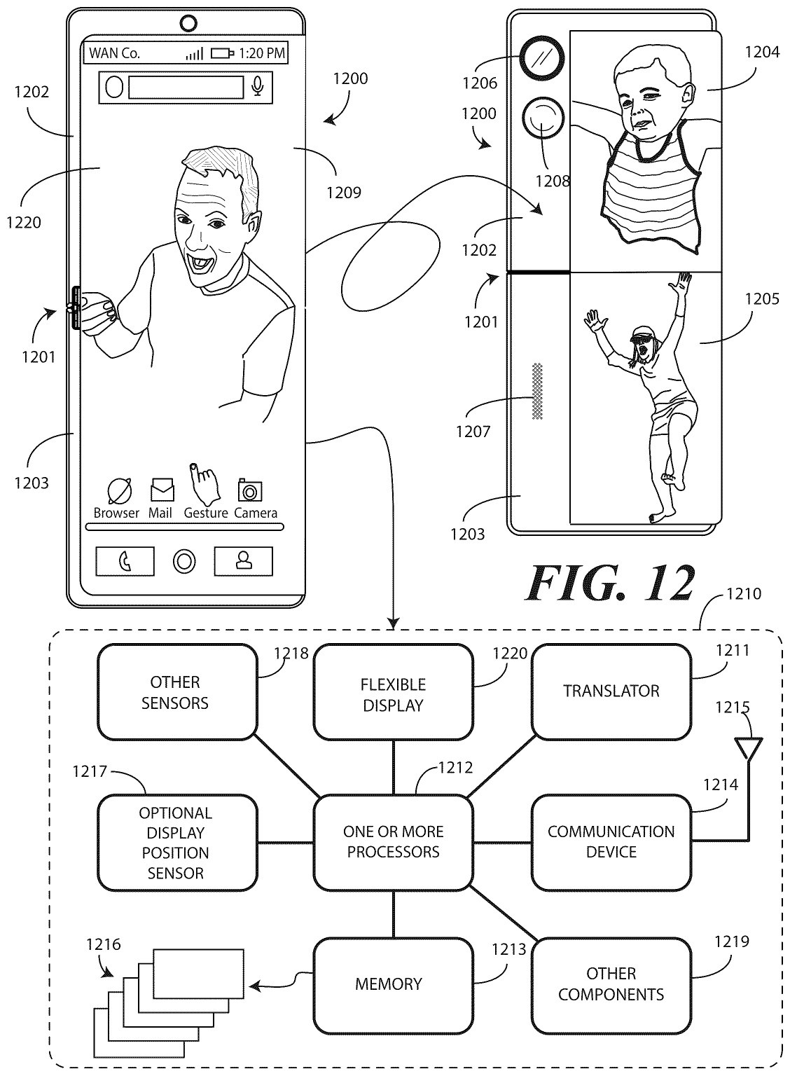

In one or more embodiments, a hinge 109 couples the first device housing 107 to the second device housing 108. In one or more embodiments, the first device housing 107 is selectively pivotable about the hinge 109 relative to the second device housing 108. For example, in one or more embodiments the first device housing 107 is selectively pivotable about the hinge 109 between a closed position, shown and described below with reference to FIG. 11, and an axially displaced open position, shown in FIGS. 1-3, and positions between the axially displaced open position and the closed position, one example of which is the tent position shown below with reference to FIG. 10.

In one or more embodiments the first device housing 107 and the second device housing 108 are manufactured from a rigid material such as a rigid thermoplastic, metal, or composite material, although other materials can be used. In one illustrative embodiment, each of the first device housing 107 and the second device housing 108 is manufactured from aluminum. Still other constructs will be obvious to those of ordinary skill in the art having the benefit of this disclosure.

In the illustrative embodiment of FIGS. 1-3, the electronic device 100 includes a single hinge 109. However, in other embodiments two or more hinges can be incorporated into the electronic device 100 to allow it to be folded in multiple locations.

This illustrative electronic device 100 of FIG. 1 includes a unitary flexible display 102. In one or more embodiments, the unitary flexible display 102 is coupled to the device housing 101. Specifically, a base portion 201 of the unitary flexible display 102 is coupled to a first major surface of the device housing 101. The unitary flexible display 102 then wraps around a minor surface of the device housing 101 (the right side in FIG. 2) and has at least two end portions 103, 104 that extend distally from the base portion 201.

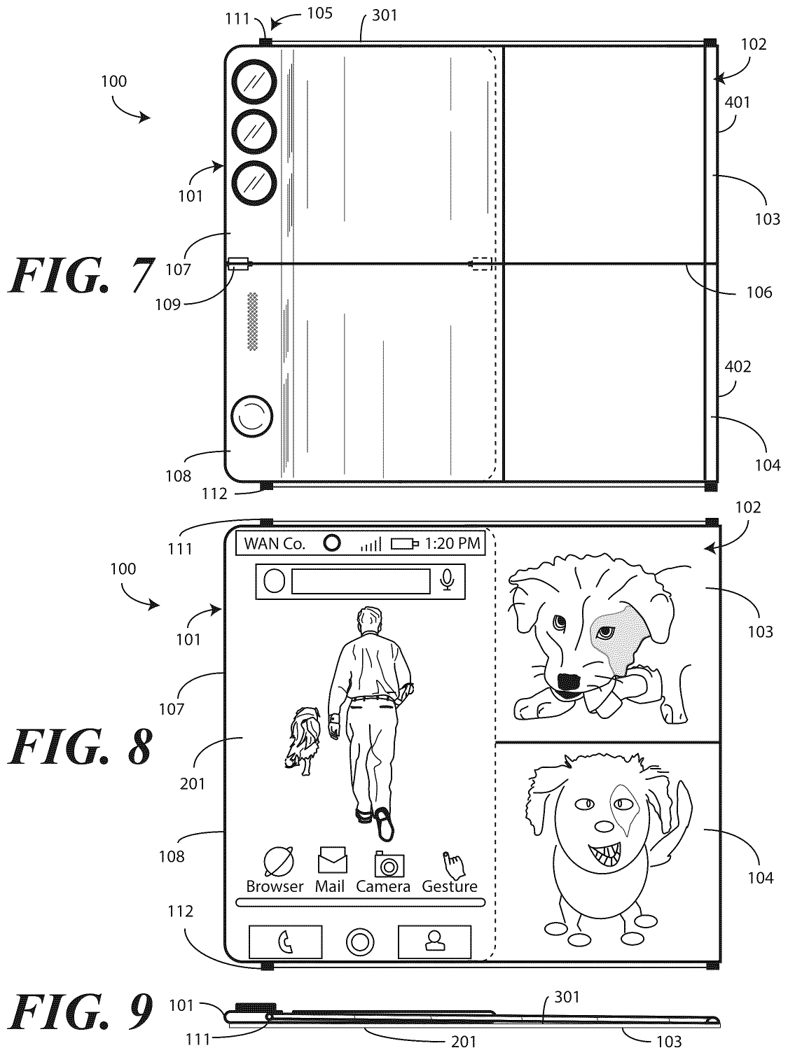

In one or more embodiments, a translator 105 is coupled to the unitary flexible display 102. The translator 105, which can include telescoping sections 301 in one or more embodiments, is operable to selectively move the at least two end portions 103,104 between a first position, shown in FIGS. 1-3, where the at least two end portions 103, 104 abut a second major surface of the device housing 101 and a second position, shown in FIGS. 7-9, where the at least two end portions 103,104 extend distally from the device housing 101.

Advantageously, this translation of the at least two end portions 103,104, combined with the fact that the first device housing 107 can pivot about the hinge 109 relative to the second device housing 108 between an axially displaced open position and a closed position, allows the electronic device 100 to transition between a tablet configuration, shown in FIGS. 7-9, when the first device housing 107 is pivoted to the axially displaced open position relative to the second device housing 108 and the first end portion 103 extends distally from the first device housing 107 and the second end portion 104 extends distally from the second device housing 108, a slab configuration, shown in FIGS. 1-3, when the first device housing 107 is pivoted to the axially displaced open position relative to the second device housing 108, the first end portion 103 abuts the first device housing 107 and the second end portion 104 abuts the second device housing 108, and a clamshell configuration, shown in FIG. 11, when the first end portion 103 abuts the first device housing 107, the second end portion 104 abuts the second device housing 108, and the first device housing 107 is pivoted relative to the second device housing 108 to the closed position.

The unitary flexible display 102 is referred to as “unitary” because the base portion 201 and the at least two end portions 103,104 are configured as one, singular, contiguous display. Said differently, since the at least two end portions 103,104 extend continuously from the base portion 201, the unitary flexible display 102 is a single component and is not multiple displays attached together to form a whole. Instead, a single substrate supports each of the base portion 201 and the at least two end portions 103,104.

Despite being a unitary flexible display 102, the various sections of the unitary flexible display 102 can operate independently and can present different content. Illustrating by example, in FIGS. 1-2, the base portion 201 is showing a user walking his dog, Buster, while the first end portion 103 presents a photo of Buster and the second end portion 104 presents a cartoon of Buster. These images are illustrative only, as others will be obvious to those of ordinary skill in the art having the benefit of this disclosure.

Accordingly, one of the key advantages of the electronic device 100 is its ability to present different content on different parts of the unitary flexible display 102. The electronic device 100 thus allows users to configure it in such a way that the base portion 201 of the unitary flexible display 102, the first end portion 103 of the unitary flexible display 102, and the second end portion 104 of the unitary flexible display 102 can each display separate content.

For example, when the electronic device 100 is in the tablet configuration, users can have content spanning the entire unitary flexible display 102, including the base portion 201 and the at least two end portions 103,104. This provides a seamless and immersive viewing experience, particularly for multimedia content such as videos, movies, and games.

In the slab configuration of FIGS. 1-3, the first end portion 103 and the second end portion 104 of the unitary flexible display 102 face in one direction, while the base portion faces in the opposite direction. In this configuration, users can have different content displayed on the base portion 201 and the at least two end portions 103,104. This allows for multitasking and efficient use of the screen real estate. For instance, users can have a document or a web page open on the base portion 201 while simultaneously viewing a video or a social media feed on the at least two end portions 103,104. Moreover, a first user can watch content on the base portion 201 while a second user can watch different content on the at least two end portions 103,104.

Similarly, in the clamshell configuration, where the electronic device 100 is folded, the first end portion 103 and the second end portion are exposed while the base portion 201 is concealed. In this configuration, users can have content displayed on the at least two end portions 103,104 while the base portion 201 remains inactive. This can be useful for quick access to notifications, messages, or other relevant information without having to unfold the electronic device 100.

The ability to configure the electronic device 100 to present different content on different parts of the unitary flexible display 102 enhances the user experience and allows for greater flexibility in how the electronic device 100 is used. It caters to the diverse needs and preferences of users, enabling them to customize their viewing and interaction experience based on their specific requirements.

In one or more embodiments, the unitary flexible display 102 can optionally be touch-sensitive. Users can deliver user input to the unitary flexible display 102 of such an embodiment by delivering touch input from a finger, stylus, or other objects disposed proximately with the unitary flexible display 102.

In one embodiment, the unitary flexible display 102 is configured as an organic light emitting diode (OLED) display fabricated on a flexible plastic substrate, thereby making the unitary flexible display 102 a flexible display. This allows the unitary flexible display 102 to be flexible so as to deform when the translator 105 moves the at least two end portions 103,104 between the first position and the second position. In one or more embodiments, the unitary flexible display 102 is constructed on flexible plastic substrates can allow the flexible display to bend with various bending radii.

Features can be incorporated into the first device housing 107 and/or the second device housing 108. Examples of such features include an optional image capture device 113 or an optional speaker port 114, which are shown disposed on the rear side of the electronic device 100 in this embodiment but could be placed on the front side as well. In this illustrative embodiment, a user interface component 115, which may be a button or touch sensitive surface, can also be disposed along the rear side of the second device housing 108. As noted, any of these features are shown being disposed on the rear side of the electronic device 100 in this embodiment, but could be located elsewhere, such as on the front side in other embodiments.

In one embodiment, the electronic device 100 includes one or more connectors, which can include an analog connector, a digital connector, or combinations thereof. Illustrating by example, an analog connector can be disposed on a first end, e.g., the top end, of the electronic device 100, while a digital connector disposed on a second end opposite the first end, such as the bottom end.

In one or more embodiments the unitary flexible display 102 may be formed from multiple layers of flexible material such as flexible sheets of polymer or other materials. In this illustrative embodiment, the base portion 201 of the unitary flexible display 102 is fixedly coupled to the front side of the first device housing 107. However, the at least two end portions 103,104 are separable from the right side of the device housing 101 and the rear side of the device housing 101. The unitary flexible display 102 spans a minor surface of the device housing 101 in this illustrative embodiment.

In the illustrative embodiment of FIGS. 1-3, the at least two end portions 103,104 comprise a first end portion 103 separated from a second end portion 104 by a slit 106. In this illustrative embodiment, the first end portion 103 and the second end portion 104 abut each other along the slit 106.

In the explanatory unitary flexible display 102 depicted in FIGS. 1-3, there are exactly two end portions 103,104 that extend distally away from the base portion 201. This configuration allows for a versatile display that can be manipulated and adjusted to different positions and orientations. However, it is important to note that in other embodiments, the number of end portions 103,104 can vary based on the specific application and design requirements. Depending on the desired functionality and form factor of the electronic device 100, more or fewer than two end portions 103,104 can be utilized. This flexibility allows for customization and adaptation to different use cases, ensuring that the device can meet the specific needs and preferences of users.

In one or more embodiments, the translator 105 comprises a pair of telescoping sections 301, with one telescoping section being situated at the top of the electronic device 100 and coupled to the first end portion 103, while a second telescoping section is situated at the bottom of the electronic device 100 and is coupled to the second end portion 104. In such a configuration, the first telescoping section defines a first translation arm 111 coupled to an end of the first end portion 103, while the second telescoping section defines a second translation arm 112 coupled to another end of the second end portion 104. This is shown in more detail in FIGS. 6 and 9 below.

The use of telescoping sections 301 that can extend and retract, allowing for the movement of the end portions 103,104, works well in practice in that it provides a reliable and efficient mechanism for transitioning the at least two end portions 103,104 between different configurations.

However, it is important to note that other types of translators 105 can also be used to achieve the same purpose. For example, a sliding mechanism could be employed, where the end portions slide along a track or rail to move the at least two end portions 103,104 between the first and second positions. This sliding mechanism could be motorized or manually operated, depending on the design and functionality requirements of the device.

Another alternative translator 105 could involve the use of a folding mechanism, where the at least two end portions 103,104 fold or unfold to transition between the positions. This folding mechanism could utilize hinges or other types of articulating joints to facilitate the movement.

Additionally, a combination of different translators 105 could be employed, depending on the specific design and functionality goals of the device. For instance, a telescoping arm 301 could be used in conjunction with a sliding mechanism to provide enhanced flexibility and stability in the movement of the at least two end portions 103,104.

It will be obvious to those of ordinary skill in the art having the benefit of this disclosure that the choice of translator 105 will depend on various factors, including the desired level of complexity, durability, and ease of use. The specific implementation of the translator 105 will be determined based on the overall design and engineering considerations of the electronic device 100.

In summary, while an explanatory translator 105 utilizes a telescoping arm, it is important to recognize that other types of translators 105 can be utilized to achieve the movement of the at least two end portions 103,104 of the unitary flexible display 102. The selection of the type of translator 105 will depend on the specific requirements and objectives of the device, ensuring optimal functionality and user experience.

In one or more embodiments, the translator 105 is operable to selectively move the at least two end portions 103, 104 from the first position where they abut the rear major surface of the device housing 101 and the second position where they extend distally away from the device housing 101 only when the first device housing 107 is pivoted to the axially displaced open position relative to the second device housing 108. This prevents the at least two end portions 103,104 from extending, say, when the electronic device 100 is in a clamshell configuration and situated within a pocket.

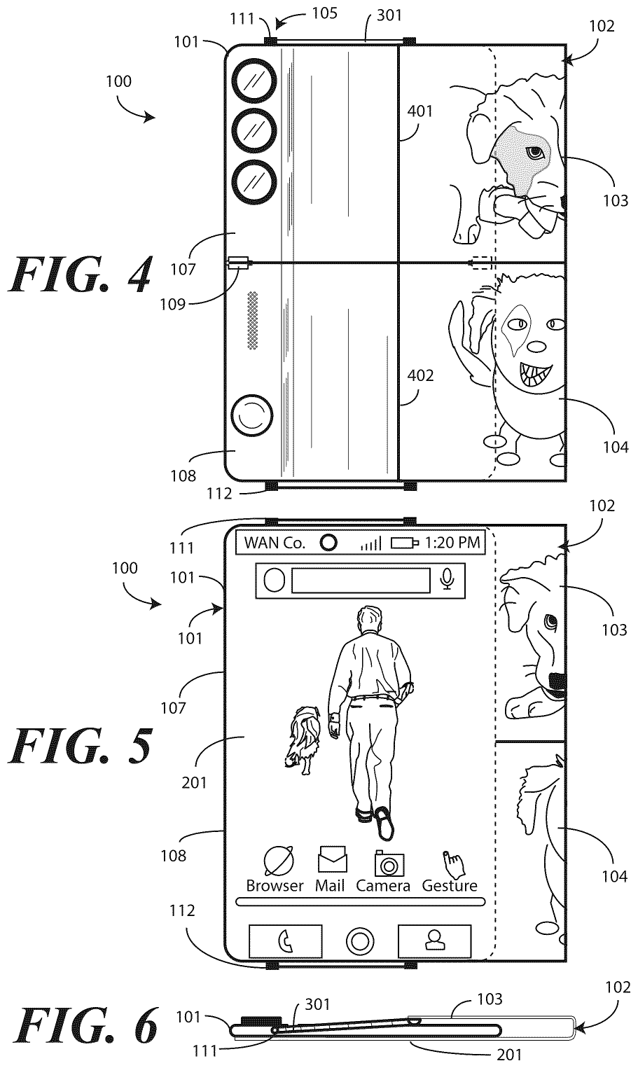

Turning now to FIGS. 4-6, the electronic device 100 is again shown with the first device housing 107 and the second device housing 108 pivoted relative to each other about the hinge 109 to the axially displaced open position. However, rather than being in the slab configuration of FIGS. 1-3, the telescoping sections 301 of the translator 105 are moving the at least two end portions 103,104, and more particularly the edges 401,402 of the at least two end portions 103,104 toward the second position where they extend distally from the device housing 101. Said differently, the first translation arm 111 coupled to an end of the first end portion 103 moves that first end portion 103 from right to left by expanding, while the second translation arm 112 coupled to another end of the second end portion 104 does the same.

In one or more embodiments, this occurs when the telescoping sections 301 expand, thereby pushing the edges 401,402 of the at least two end portions 103,104 along the rear major surface of the device housing 101. In one or more embodiments, this results in the unitary flexible display 102 being configured as a block U-shape, as shown in FIG. 6.

In the depicted embodiment of the electronic device 100 found in FIGS. 4-6, the at least two end portions 103, 104 of the unitary flexible display 102 move at the same rate in response to the expansion of the telescoping arms 301. This synchronized movement ensures a uniform extension and retraction of the at least two end portions 103,104 of the unitary flexible display 102. However, it is worth noting that in other embodiments, the edges 401,402 of the at least two end portions 103,104 can move at different speeds or by different amounts.

Allowing the edges 401,402 of the at least two end portions 103,104 to move at different rates or by different amounts can offer several benefits. Firstly, it enables the electronic device 100 to accommodate varying content presentation requirements. For instance, if a user wants to emphasize or prioritize the content displayed on one end portion over the other, the ability to adjust the movement of the edges 401,402 of the at least two end portions 103,104 independently allows for a more tailored viewing experience.

Additionally, moving the edges 401,402 of the at least two end portions 103,104 at different rates or by different amounts can enhance the device's versatility. It enables the creation of unique configurations and usage scenarios. For example, the electronic device 100 could be configured to display a larger portion of a specific app or content on one end portion while reserving the other end portion for notifications or secondary tasks. This flexibility allows users to optimize their multitasking capabilities and customize their device usage based on their preferences and needs.

Furthermore, the ability to move the edges 401,402 of the at least two end portions 103,104 independently can contribute to the overall aesthetics and design of the electronic device 100. It allows for asymmetrical or dynamic visual compositions, which can be visually appealing and create a sense of innovation and uniqueness.

In summary, while the depicted embodiment shows the at least two end portions 103,104 of the unitary flexible display 102 moving at the same rate, other embodiments can explore the option of moving the edges 401,402 of the at least two end portions 103,104 at different speeds or by different amounts. This flexibility offers benefits such as tailored content display, enhanced versatility, and unique design possibilities, ultimately enhancing the user experience and satisfaction with the electronic device 100.

Since the base portion 201 of the unitary flexible display 102 is fixedly coupled to the front major surface of the device housing 101, it remains flat against the front major surface as the telescoping sections 301 expand. This ensures that the base portion 201 maintains a stable and consistent position, providing a solid foundation for the unitary flexible display 102. On the other hand, in one or more embodiments the at least two end portions 103,104 are allowed to separate as the translator 105 moves them away from the rear major surface of the device housing 101.

This mode of operation offers several benefits. Firstly, it allows for a seamless and uninterrupted viewing experience on the base portion 201 of the unitary flexible display 102. By remaining flat against the front major surface, the base portion 201 provides a stable and level surface for content to be displayed, ensuring optimal visibility and readability.

Additionally, the separation of the at least two end portions 103,104 from the rear major surface of the device housing 101 creates a sense of depth and dimensionality in the unitary flexible display 102. This can enhance the visual experience, particularly when viewing multimedia content or engaging in immersive applications.

Furthermore, the separation of the at least two end portions 103,104 allows for increased flexibility in the positioning and orientation of the unitary flexible display 102. Users can adjust the angle and curvature of the at least two end portions 103,104 by fiddling with the translator 105 to achieve the desired viewing angle or ergonomic comfort in one or more embodiments. This adaptability enhances user comfort and usability, accommodating different preferences and usage scenarios.

Overall, the fixed positioning of the base portion 201 and the separation of the at least two end portions 103,104 of the unitary flexible display 102 contribute to a stable and versatile display experience. It ensures optimal visibility, depth, and flexibility, enhancing the overall user experience with the electronic device 100.

Turning now to FIGS. 7-9, the electronic device 100 is again shown with the first device housing 107 and the second device housing 108 pivoted relative to each other about the hinge 109 to the axially displaced open position. However, rather than being in the slab configuration of FIGS. 1-3, the telescoping sections 301 of the translator 105 has used the telescoping sections 301 of the first translation arm 111 and the second translation arm to move the at least two end portions 103,104 such that they extend distally away from the device housing 101, thereby placing the electronic device 100 in the tablet configuration. More particularly the translator 105 has expanded the telescoping sections 301 such that edges 401,402 of the at least two end portions 103,104 are in the second position where they extend distally from the device housing 101.

When the at least two end portions 103,104 are returned to the retracted position of FIGS. 1-3, the first device housing 107 and second device housing 108 of the overall device housing 101 can be pivoted relative to each other to transition the electronic device 100 into other configurations. Illustrating by example, turning now to FIG. 10, here the first device housing 107 has been pivoted about the hinge 109 relative to the second device housing 108 partially between the axially displaced open position of FIGS. 1-9 and the closed position of FIG. 11 into a “tent” position 1010.

In one or more embodiments, when in the tent position 1010 the first portion if the unitary flexible display 102 defined by the first end portion (103) abuts the first device housing 107, while the second portion of the unitary flexible display 102 defined by the second end portion (104) abuts the second device housing. 108. Moreover, the first device housing 107 is partially pivoted relative to the second device housing 108 to another position between the axially displaced open position and the closed position.

When the electronic device 100 is in the tent position 1010, it offers a unique mode of operation where a first user can watch first content on the first end portion (103) of the unitary flexible display 102, while another user can simultaneously watch different content on the second end portion (104) of the unitary flexible display 102. This mode of operation provides several benefits and advantages.

Firstly, it allows for enhanced multitasking and shared viewing experiences. The electronic device 100 can be positioned in a way that creates a natural separation between the two end portions (103,104), enabling two users to enjoy their preferred content simultaneously without any interference. This is particularly useful in scenarios where multiple users want to watch different videos, movies, or streams, or engage in separate applications or activities.

Secondly, this mode of operation promotes collaboration and interaction. It enables users to share and discuss content in real-time, fostering engagement and social interaction. For example, one user can watch a tutorial or presentation on one end portion while the other user follows along with related content or takes notes on the second end portion. This collaborative aspect enhances productivity and learning experiences.

Furthermore, the ability to watch different content on each end portion provides a personalized and customizable viewing experience. Users can choose content that aligns with their individual preferences, interests, or needs. This mode of operation caters to diverse user preferences and allows for a more tailored and enjoyable user experience.

Additionally, this mode of operation can be beneficial in various settings, such as educational environments, business meetings, or entertainment venues. It enables instructors, presenters, or hosts to deliver content to a group while allowing individuals to focus on their specific areas of interest or follow along with supplementary material.

Overall, the ability to watch different content on the first and second end portions of the unitary flexible display 102 in the tent position offers enhanced multitasking, collaboration, personalization, and flexibility. It enriches the user experience and expands the possibilities for shared and individual content consumption in a single device.

Turning now to FIG. 11, in this illustration the first device housing 107 has been pivoted about the hinge 109 relative to the second device housing 108 to the closed position 1110. This puts the electronic device 100 in the clamshell configuration. When in the closed position, the base portion (201) of the unitary flexible display 102 is concealed and the first end portion (103) and the second end portion (104) are exposed when the first end portion (103) and the second end portion (104) are in the first position and the first device housing 107 is pivoted relative to the second device housing 108 to the closed position.

When the first device housing 107 is pivoted about the hinge 109 relative to the second device housing 108 to the closed position 1110, and the electronic device 100 is placed on a table such as shown in FIG. 11, a unique mode of operation can be achieved. In this configuration, the base portion (201) of the unitary flexible display 102 and the second end portion (104) can be deactivated, placed into a low power mode, or even put into a sleep mode. This mode of operation offers several benefits and advantages.

Firstly, deactivating or placing the base portion (201) and the second end portion (104) into a low power or sleep mode helps conserve battery life. When the electronic device 100 is placed on a table and not actively being used, there is no need for the entire unitary flexible display 102 to remain active. By selectively deactivating or reducing power to specific portions of the unitary flexible display 102, energy consumption can be minimized, resulting in extended battery life and improved overall efficiency.

Additionally, this mode of operation can prevent accidental touches or interactions with the base portion (201) and the second end portion (104). When the electronic device 100 is placed on a table, there is a higher likelihood of unintended touches or gestures on these areas of the unitary flexible display 102. By deactivating or placing them into a low power or sleep mode, the electronic device 100 can prevent unintended actions, ensuring a more seamless and uninterrupted user experience.

Furthermore, this mode of operation can contribute to a more focused and distraction-free environment. By deactivating or placing the base portion (201) and the second end portion (104) into a low power or sleep mode, users can concentrate on the content displayed on the remaining active portion of the unitary flexible display 102. This can be particularly beneficial in scenarios where users need to focus on specific tasks or content without being distracted by notifications or secondary information.

Moreover, placing the base portion (201) and the second end portion (104) into a low power or sleep mode can help reduce visual clutter and enhance the aesthetic appeal of the device. By dimming or deactivating these areas, the active portion of the unitary flexible display 102 becomes the main focal point, creating a cleaner and more visually pleasing appearance.

In summary, when the electronic device 100 is placed on a table and the base portion (201) and the second end portion (104) are deactivated, placed into a low power mode, or put into a sleep mode, it offers benefits such as improved battery life, prevention of accidental touches, a focused user experience, and enhanced aesthetics. This mode of operation optimizes power consumption, reduces distractions, and creates a more streamlined and efficient user interaction with the electronic device 100.

Turning now to FIG. 12, illustrated therein is another explanatory electronic device 1200 configured in accordance with one or more embodiments of the disclosure. As before, the electronic device 1200 comprises a first device housing 1202 that is pivotable relative to a second device housing 1203 about a hinge 1201 between a demonstration operation and a closed position. The electronic device 1200 includes a unitary flexible display 1220 having a base portion 1209, a first portion 1204 extending from the base portion 1209 that is selectively extendable from the first device housing 1202, and a second portion 1205 that extends from the base portion 1209 and that is selectively extendable from the second device housing 1203.

As before, the electronic device 1200 is operable in different configurations. In one or more embodiments, these configurations include a tablet configuration when the first device housing. 1202 is pivoted to the axially displaced open position relative to the second device housing 1203, the first portion 1204 extends distally from the first device housing 1202, and the second portion 1205 extends distally from the second device housing 1203, a slab configuration when the first device housing 1202 is pivoted to the axially displaced open position relative to the second device housing 1203, the first portion 1204 abuts the first device housing 1202, and the second portion 1205 abuts the second device housing 1203, and a clamshell configuration when the first portion 1204 abuts the first device housing 1202, the second portion 1205 abuts the second device housing 1203, and the first device housing 1202 is pivoted relative to the second device housing 1203 to the closed position.

Of course, the first device housing 1202 can be pivoted relative to the second device housing 1203 to positions between the axially displaced open position and the closed position as well. Illustrating by example, another configuration comprises a tent configuration when the first portion 1204 abuts the first device housing 1202, the second portion 1205 abuts the second device housing 1203, and the first device housing 1202 is partially pivoted relative to the second device housing 1203 to another position between the axially displaced open position and the closed position. The advantages of each position have been described in detail above. Other advantages will be obvious to those of ordinary skill in the art having the benefit of this disclosure.

As before, in one or more embodiments the unitary flexible display 1220 can optionally be touch-sensitive. Users can deliver user input to the unitary flexible display 1220 of such an embodiment by delivering touch input from a finger, stylus, or other objects disposed proximately with the unitary flexible display 1220.

In one or more embodiments the unitary flexible display 1220 may be formed from multiple layers of flexible material such as flexible sheets of polymer or other materials. In this illustrative embodiment, the unitary flexible display 1220 is fixedly coupled to the front major surface of first device housing 1202 and the second device housing 1203. The unitary flexible display 1220 spans a minor surface of the first device housing 1202 and second device housing 1203 in this illustrative embodiment.

Features can be incorporated into the first device housing 1202 and/or the second device housing 1203. Examples of such features include a camera 1206 or an optional speaker port 1207, which are shown disposed on the rear side of the electronic device 1200 in this embodiment but could be placed on the front side as well. In this illustrative embodiment, a user interface component 1208, which may be a button, fingerprint sensor, or touch sensitive surface, can also be disposed along the rear side of the first device housing 1202. As noted, any of these features are shown being disposed on the rear side of the electronic device 1200 in this embodiment, but could be located elsewhere, such as on the front side in other embodiments. In other embodiments, these features may be omitted.

A block diagram schematic 1210 of the electronic device 1200 is also shown in FIG. 122. The block diagram schematic 110 includes one or more electronics components that can be coupled to a printed circuit board assembly disposed within either or both of the first device housing 1202 or the second device housing 1203 of the electronic device 1200. The components can be electrically coupled together by conductors, or a bus disposed along one or more printed circuit boards.

For example, some components of the block diagram schematic 1210 can be configured as a first electronic circuit fixedly situated within the first device housing 1202, while other components of the block diagram schematic 1210 can be configured as a second electronic circuit fixedly situated within the second device housing 1203. In one or more embodiments, a flexible substrate can then span the hinge 1201 to electrically couple the first electronic circuit to the second electronic circuit.

In one or more embodiments, the electronic device 1200 includes one or more processors 1212. In one embodiment, the one or more processors 1212 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 1200. A storage device, such as memory 1213, can optionally store the executable software code used by the one or more processors 1212 during operation.

In this illustrative embodiment, the electronic device 1200 also includes a communication circuit 1214 that can be configured for wired or wireless communication with one or more other devices or networks. The networks can include a wide area network, a local area network, and/or personal area network. The communication circuit 1214 may also utilize wireless technology for communication, such as, but are not limited to, peer-to-peer or ad hoc communications such as HomeRF, Bluetooth and IEEE 802.11, and other forms of wireless communication such as infrared technology. The communication circuit 1214 can include wireless communication circuitry, one of a receiver, a transmitter, or transceiver, and one or more antennas 1215.

In one embodiment, the one or more processors 1212 can be responsible for performing the primary functions of the electronic device 1200. For example, in one embodiment the one or more processors 1212 comprise one or more circuits operable with one or more user interface devices, which can include the unitary flexible display 1220, to present, images, video, or other presentation information to a user. The executable software code used by the one or more processors 1212 can be configured as one or more modules 1216 that are operable with the one or more processors 1212. Such modules 1216 can store instructions, control algorithms, logic steps, and so forth.

In one embodiment, the one or more processors 1212 are responsible for running the operating system environment of the electronic device 1200. The operating system environment can include a kernel and one or more drivers, and an application service layer, and an application layer. The operating system environment can be configured as executable code operating on one or more processors or control circuits of the electronic device 1200. The application layer can be responsible for executing application service modules. The application service modules may support one or more applications or “apps.” The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the electronic device 1200 optionally includes an optional display position sensor 1217 configured to determine whether the first portion 1204 of the unitary flexible display 1220 and the second portion 1205 of the unitary flexible display 1220 are in the first position where they abut the first device housing 1202 and second device housing 1203, respectively, the second position where they extend distally from the first device housing 1202 and the second device housing 1203, respectively, or somewhere in between. In one or more embodiments, the optional display position sensor 1217 is further operable with the one or more processors 1212 to detect a bending operation that causes the first device housing 1202 to pivot about the hinge 1201 relative to the second device housing 1203, thereby transforming the electronic device 1200 into a deformed geometry, such as that shown in FIGS. 10-11 above. The inclusion of the display position sensor 1217 is optional, and in some embodiment the display position sensor 1217 will not be included.

In one embodiment, the one or more processors 1212 may generate commands or execute control operations based on information received from the various sensors, including the one or optional display position sensor 1217, the flexible display 120, or the other sensors 1218. The one or more processors 1212 may also generate commands or execute control operations based upon information received from a combination of the optional display position sensor 1217, the unitary flexible display 1220, or the other sensors 1218. Alternatively, the one or more processors 1212 can generate commands or execute control operations based upon information received from the optional display position sensor 1217 or the unitary flexible display 1220 alone. Moreover, the one or more processors 1212 may process the received information alone or in combination with other data, such as the information stored in the memory 1213.

The one or more other sensors 1218 may include a microphone, an earpiece speaker, a second loudspeaker (disposed beneath speaker port 1207), and a user interface component such as a button or touch-sensitive surface. The one or more other sensors 1218 may also include key selection sensors, proximity sensors, a touch pad sensor, a touch screen sensor, a capacitive touch sensor, and one or more switches.

Touch sensors may be used to indicate whether any of the user actuation targets present on the unitary flexible display 1220 are being actuated. Alternatively, touch sensors disposed in the electronic device 1200 can be used to determine whether the electronic device 1200 is being touched at side edges or major faces of the first device housing 1202 or the second device housing 1203. The touch sensors can include surface and/or housing capacitive sensors in one embodiment. The other sensors 1218 can also include audio sensors and video sensors (such as a camera).

The other sensors 1218 can also include motion detectors, such as one or more accelerometers or gyroscopes. For example, an accelerometer may be embedded in the electronic circuitry of the electronic device 1200 to show vertical orientation, constant tilt and/or whether the electronic device 1200 is stationary. A gyroscope can be used in a similar fashion.

Other components 1219 operable with the one or more processors 1212 can include output components such as video outputs, audio outputs, and/or mechanical outputs. Examples of output components include audio outputs such as speaker port 1207, earpiece speaker, or other alarms and/or buzzers and/or a mechanical output component such as vibrating or motion-based mechanisms. Still other components will be obvious to those of ordinary skill in the art having the benefit of this disclosure.

In one or more embodiments, a translator 1211 comprises a first translator coupled between the first device housing 1202 and the first portion 1204 of the unitary flexible display 1220 and as second translator coupled between the second device housing 1203 and the second portion 1205 of the unitary flexible display 1220. In one or more embodiments, this translator 1211 is operable to move the first portion 1204 and the second portion 1205 between the first position and the second position as previously described.

It is to be understood that FIG. 12 is provided for illustrative purposes only and for illustrating components of one electronic device 1200 in accordance with embodiments of the disclosure and is not intended to be a complete schematic diagram of the various components required for an electronic device. Therefore, other electronic devices in accordance with embodiments of the disclosure may include various other components not shown in FIG. 12 or may include a combination of two or more components or a division of a particular component into two or more separate components, and still be within the scope of the present disclosure. Illustrating by example, as will be described in more detail below, some embodiments include support plates that are pivotally coupled to a hinge housing of the hinge 1201. In other embodiments, these support plates will be omitted.

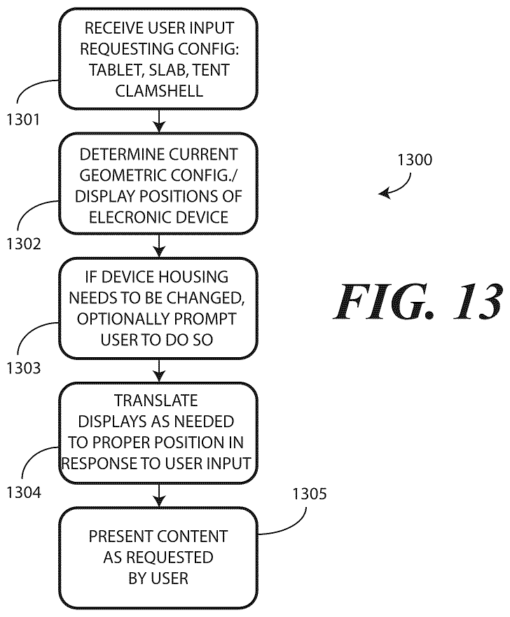

Turning now to FIG. 13, illustrated therein is one explanatory method 1300 for using an electronic device configured in accordance with one or more embodiments of the disclosure. Beginning at step 1301, the method 1300 receives, by a user interface such as that defined by a unitary flexible display, user input requesting that a unitary flexible display coupled to a device housing and having at least two separated end portions extending distally from a base portion to transition the at least two separated end portions between a first position where the at least two separated end portions abut the device housing and a second position where the at least two separated end portions extend distally from the device housing.

Step 1302 then determines a current geometric configuration of the electronic device. Step 1302 can also determine the positions of the at least two separated end portions relative to the device housings. Embodiments of the disclosure contemplate that in some configurations, the at least two separated end portions will only be allowed to transition to the second position when the device housing is defined by a first device housing that is pivotable relative to a second device housing between an axially displaced open position and closed position, with the first device housing and second device housing being pivoted to the axially displaced open position. Accordingly, step 1302 can optionally determine the geometric configuration of the electronic device. Moreover, when determining the positions of the at least two separated end portions step 1302 can determine if any translation of the at least two separated end portions is required in response to the user input.

Optional step 1303 can comprise prompting the user to move the device housings to a particular position. Again, embodiments of the disclosure contemplate that in some configurations, the at least two separated end portions will only be allowed to transition to the second position when the device housing is defined by a first device housing that is pivotable relative to a second device housing between an axially displaced open position and closed position, with the first device housing and second device housing being pivoted to the axially displaced open position. Thus, if the user input received at step 1301 requests the at least two separated end portions to move to the second position where they extend from a first device housing and second device housing, and the first device housing and second device housing are in a closed position, in one or more embodiments optional step 1303 can comprise prompting the user to pivot the first device housing and second device housing to the axially displaced open position. Thus, in one or more embodiments step 1303 comprises prompting, by a user interface, for a first device housing portion of the device housing to be pivoted relative to a second device housing portion of the device housing between an axially displaced open position and a closed position.

At step 1304, a translator coupled to the unitary flexible display translates the at least two separated end portions in response to the user input received at step 1301. In one or more embodiments, step 1304 comprises extending telescoping arms of the translator as previously described. Step 1305 can then comprise presenting content as a function of the position of the at least two separated end portions relative to the base portion of the unitary flexible display.

Illustrating by example, in one or more embodiments step 1305 comprises presenting first content on the at least two separated end portions of the unitary flexible display and second content that is different from the first content on the base portion of the unitary flexible display when a first device housing portion of the device housing is pivoted relative to a second device housing portion of the device housing to an axially displaced open position and the at least two separated end portions of the unitary flexible display are in the first position. Similarly, in other situations step 1305 can comprise presenting content spanning the base portion of the unitary flexible display and the at least two separated end portions of the unitary flexible display when a first device housing portion of the device housing is pivoted relative to a second device housing portion of the device housing to an axially displaced open position and the at least two separated end portions of the unitary flexible display are in the second position.

Step 1305 can also comprise precluding the presentation of content. Illustrating by example, in one or more embodiments step 1305 comprises precluding presentation of content on the base portion of the unitary flexible display when a first device housing portion of the device housing is pivoted relative to a second device housing portion of the device housing to a closed position and the at least two separated end portions of the unitary flexible display are in the first position.

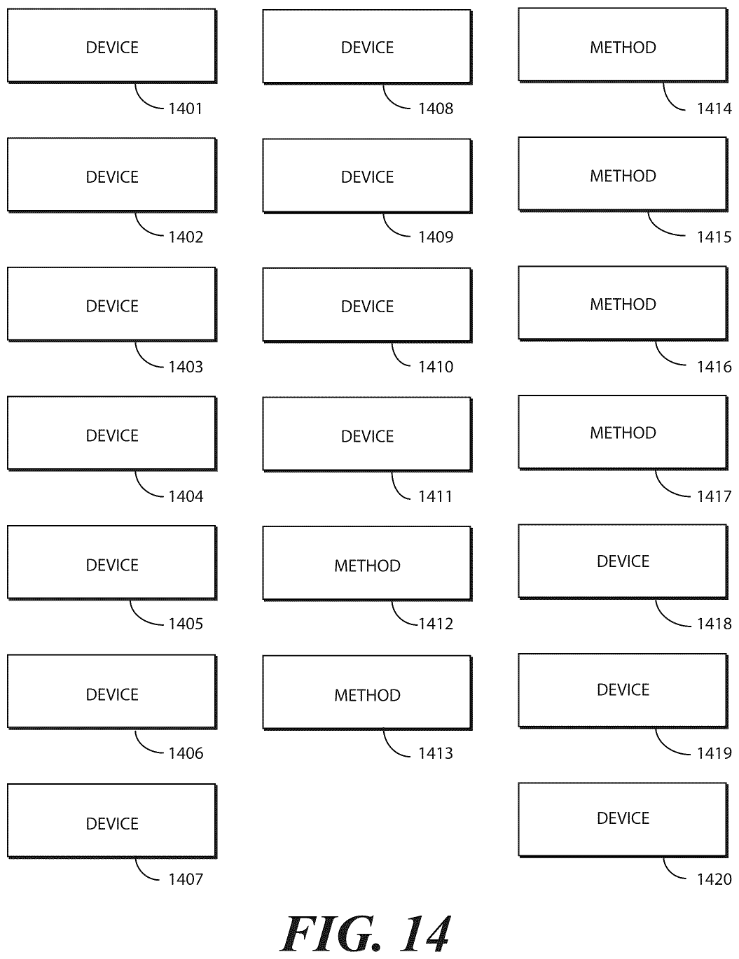

Turning now to FIG. 14, illustrated therein are various embodiments of the disclosure. The embodiments of FIG. 14 are shown as labeled boxes in FIG. 14 due to the fact that the individual components of these embodiments have been illustrated in detail in FIGS. 1-14, which precede FIG. 15. Accordingly, since these items have previously been illustrated and described, their repeated illustration is no longer essential for a proper understanding of these embodiments. Thus, the embodiments are shown as labeled boxes.

At 1401, an electronic device comprises a device housing, a unitary flexible display coupled to the device housing and having at least two end portions extending distally from a base portion, and a translator coupled to the unitary flexible display. At 1401, the translator is operable to selectively move the at least two end portions between a first position where the at least two end portions abut the device housing and a second position where the at least two end portions extend distally from the device housing.

At 1402, the at least two end portions of 1401 comprise a first end portion separated from a second end portion by a slit. At 1403, the first end portion and second end portion of 1402 abut along the slit.

At 1404, the device housing of 1403 comprises a first device housing pivotable relative to a second device housing between an axially displaced open position and a closed position. AT 1405, the first device housing of 1404 is pivotable about a hinge relative to the second device housing between the axially displaced open position and the closed position.

At 1406, the translator of 1404 is operable to selectively move the at least two end portions from the first position where they abut the device housing and the second position where they extend distally from the device housing only when the first device housing is pivoted to the axially displaced open position relative to the second device housing. At 1407, the base portion of the unitary flexible display of 1404 is concealed and the first end portion and the second end portion are exposed when the first end portion and the second end portion are in the first position and the first device housing is pivoted relative to the second device housing to the closed position.

At 1408, the translator of 1402 comprises a first translation arm coupled to an end of the first end portion and a second translation arm coupled to an end of the second end portion. At 1409, the first translation arm of 1408 and the second translation arm comprise telescoping sections.

At 1410, the base portion of 1401 is fixedly coupled to a first major surface of the device housing and the at least two end portions abut a second major surface of the device housing when in the first position. At 1411. The illuminative fabric display pf 1401 is configured as in a block U-shape.

At 1412, a method in an electronic device comprises receiving, by a user interface, user input requesting a unitary flexible display coupled to a device housing and having at least two separated end portions extending distally from a base portion to transition the at least two separated end portions between a first position where the at least two separated end portions abut the device housing and a second position where the at least two separated end portions extend distally from the device housing. At 1412, the method comprises translating, by a translator coupled to the unitary flexible display, the at least two separated end portions in response to the user input.

At 1413, the method of 1412 further comprises prompting, by the user interface, for a first device housing portion of the device housing to be pivoted relative to a second device housing portion of the device housing between an axially displaced open position and a closed position. At 1414, the method of 1412 further comprises presenting first content on the at least two separated end portions of the unitary flexible display and second content that is different from the first content on the base portion of the unitary flexible display when a first device housing portion of the device housing is pivoted relative to a second device housing portion of the device housing to an axially displaced open position and the at least two separated end portions of the unitary flexible display are in the first position.

At 1415, the method of 1412 further comprises presenting content spanning the base portion of the unitary flexible display and the at least two separated end portions of the unitary flexible display when a first device housing portion of the device housing is pivoted relative to a second device housing portion of the device housing to an axially displaced open position and the at least two separated end portions of the unitary flexible display are in the second position. At 1416, the method of 1412 further comprises precluding presentation of content on the base portion of the unitary flexible display when a first device housing portion of the device housing is pivoted relative to a second device housing portion of the device housing to a closed position and the at least two separated end portions of the unitary flexible display are in the first position. At 1417, the translating of 1412 comprises extending telescoping arms of the translator.

At 1418, an electronic device comprises a first device housing that is pivotable relative to a second device housing between an axially displaced open position and a closed position and a unitary flexible display having a base portion, a first portion extending from the base portion that is selectively extendable from the first device housing, and a second portion extending from the base portion that is selectively extendable from the second device housing. At 1418, the electronic device is operable in configurations comprising a tablet configuration when the first device housing is pivoted to the axially displaced open position relative to the second device housing, the first portion extends distally from the first device housing, and the second portion extends distally from the second device housing, a slab configuration when the first device housing is pivoted to the axially displaced open position relative to the second device housing, the first portion abuts the first device housing, and the second portion abuts the second device housing, and a clamshell configuration when the first portion abuts the first device housing, the second portion abuts the second device housing, and the first device housing is pivoted relative to the second device housing to the closed position.

At 1419, the configurations of 1418 further comprise a tent configuration when the first portion abuts the first device housing, the second portion abuts the second device housing, and the first device housing is partially pivoted relative to the second device housing to another position between the axially displaced open position and the closed position. At 1420, the electronic device of 1418 further comprises a first translator coupled between the first device housing and the first portion, and a second translator coupled between the second device housing and the second portion.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, electronic devices configured in accordance with embodiments of the disclosure provide an enhanced user experience in that the foldable and rollable device offers a unique and immersive user experience. The ability to transform the device between different configurations provides users with versatility and adaptability, allowing them to tailor their device usage to their specific needs and preferences.

Another advantage is space efficiency. The compact nature of the device when folded into a clamshell configuration makes it highly space efficient. This is particularly advantageous for users who have limited storage or prefer a minimalist lifestyle, as it reduces the need for additional devices or accessories.

Another advantage is durability and longevity. The design of the foldable and rollable device takes into consideration the durability and longevity of the device. The materials used and the engineering of the folding and rolling mechanisms are aimed at ensuring the device can withstand repeated use and maintain its functionality over time.

Another advantage is cost savings. By combining the functionalities of multiple devices into a single device, the invention offers potential cost savings for users. Instead of purchasing separate devices for different purposes, users can invest in a single device that fulfills their various needs, resulting in reduced expenses.

Another advantage is novelty and market appeal. The unique combination of foldability, rollability, and multiple configurations makes the device stand out in the market. Its innovative design and versatility can attract consumers who are seeking cutting-edge technology and a device that offers a distinctive user experience.

These additional benefits further highlight the advantages and value proposition of the invention, making it an appealing choice for users looking for a versatile, space-efficient, and cost-effective mobile device. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic device, comprising:
a device housing;
a unitary flexible display coupled to the device housing and having at least two end portions extending distally from a base portion; and
a translator coupled to the unitary flexible display;
wherein the translator is operable to selectively move the at least two end portions between a first position where the at least two end portions abut the device housing and a second position where the at least two end portions extend distally from the device housing.

2. The electronic device of claim 1, wherein the at least two end portions comprise a first end portion separated from a second end portion by a slit.

3. The electronic device of claim 2, wherein the first end portion and the second end portion abut along the slit.

4. The electronic device of claim 3, wherein the device housing comprises a first device housing pivotable relative to a second device housing between an axially displaced open position and a closed position.

5. The electronic device of claim 4, wherein the first device housing is pivotable about a hinge relative to the second device housing between the axially displaced open position and the closed position.

6. The electronic device of claim 4, wherein the translator is operable to selectively move the at least two end portions from the first position where they abut the device housing and the second position where they extend distally from the device housing only when the first device housing is pivoted to the axially displaced open position relative to the second device housing.

7. The electronic device of claim 4, wherein the base portion is concealed and the first end portion and the second end portion are exposed when the first end portion and the second end portion are in the first position and the first device housing is pivoted relative to the second device housing to the closed position.

8. The electronic device of claim 2, wherein the translator comprises a first translation arm coupled to an end of the first end portion and a second translation arm coupled to an end of the second end portion.

9. The electronic device of claim 8, wherein the first translation arm and the second translation arm comprise telescoping sections.

10. The electronic device of claim 1, wherein the base portion is fixedly coupled to a first major surface of the device housing and the at least two end portions abut a second major surface of the device housing when in the first position.

11. The electronic device of claim 1, wherein the unitary flexible display is configured as in a block U-shape.

12. A method in an electronic device, the method comprising:
receiving, by a user interface, user input requesting a unitary flexible display coupled to a device housing and having at least two separated end portions extending distally from a base portion to transition the at least two separated end portions between a first position where the at least two separated end portions abut the device housing and a second position where the at least two separated end portions extend distally from the device housing; and
translating, by a translator coupled to the unitary flexible display, the at least two separated end portions in response to the user input.

13. The method of claim 12, further comprising prompting, by the user interface, for a first device housing portion of the device housing to be pivoted relative to a second device housing portion of the device housing between an axially displaced open position and a closed position.

14. The method of claim 12, further comprising presenting first content on the at least two separated end portions of the unitary flexible display and second content that is different from the first content on the base portion of the unitary flexible display when a first device housing portion of the device housing is pivoted relative to a second device housing portion of the device housing to an axially displaced open position and the at least two separated end portions of the unitary flexible display are in the first position.

15. The method of claim 12, further comprising presenting content spanning the base portion of the unitary flexible display and the at least two separated end portions of the unitary flexible display when a first device housing portion of the device housing is pivoted relative to a second device housing portion of the device housing to an axially displaced open position and the at least two separated end portions of the unitary flexible display are in the second position.

16. The method of claim 12, further comprising precluding presentation of content on the base portion of the unitary flexible display when a first device housing portion of the device housing is pivoted relative to a second device housing portion of the device housing to a closed position and the at least two separated end portions of the unitary flexible display are in the first position.

17. The method of claim 12, wherein the translating comprises extending telescoping arms of a translator.

18. An electronic device, comprising:
a first device housing that is pivotable relative to a second device housing between an axially displaced open position and a closed position; and
a unitary flexible display having a base portion, a first portion extending from the base portion that is selectively extendable from the first device housing, and a second portion extending from the base portion that is selectively extendable from the second device housing;
wherein the electronic device is operable in configurations comprising:
a tablet configuration when the first device housing is pivoted to the axially displaced open position relative to the second device housing, the first portion extends distally from the first device housing, and the second portion extends distally from the second device housing;
a slab configuration when the first device housing is pivoted to the axially displaced open position relative to the second device housing, the first portion abuts the first device housing, and the second portion abuts the second device housing; and
a clamshell configuration when the first portion abuts the first device housing, the second portion abuts the second device housing, and the first device housing is pivoted relative to the second device housing to the closed position.

19. The electronic device of claim 18, wherein the configurations further comprise a tent configuration when the first portion abuts the first device housing, the second portion abuts the second device housing, and the first device housing is partially pivoted relative to the second device housing to another position between the axially displaced open position and the closed position.

20. The electronic device of claim 18, further comprising a first translator coupled between the first device housing and the first portion and a second translator coupled between the second device housing and the second portion.
